(19) United States
(12) Patent Application Publication
(10) Pub. No.: US 2001/0024089 A1
(43) Pub. Date: Sep. 27, 2001

(54) Outer seals for shrink-sealed metal halide arc tubes

(76) Inventors: Mark E. Duffy, Shaker Hts., OH (US); Christina K. Clement, Cleveland Hts., OH (US); Eugene A. Smith, Brunswick, OH (US)

Correspondence Address: PEARNE & GORDON LLP, 526 SUPERIOR AVENUE EAST, SUITE 1200, CLEVELAND, OH, 44114-1484, US

(21) Appl. No.: 09/817,653

(22) Filed: Mar. 26, 2001

(30) Foreign Application Priority Data
Mar. 23, 2000 (KR) 2000-148818

(51) Int. Cl. H01J 9/32

(52) U.S. Cl. 313/623; 445/26; 445/43

(57) ABSTRACT

A method of producing a metal halide arc tube is provided, in which four seals are made in the arc tube body. Electrode assemblies are inserted and the arc tube body is sealed at one end, blocking contamination from that end. A second seal encloses the electrode assembly nearer the first seal. Halide and mercury doses are introduced into the central arc chamber through the open end of the arc tube body. A third seal is made at the open end at a distance from the arc chamber, reducing vaporization of the doses and contamination of equipment. A fourth seal encloses the electrode assembly nearer the third seal. The electrode assemblies are thus protected and a reflective coating may be applied without electrode contamination. The ends of the arc tube body are then removed, exposing the electrodes. The arc tube is thus provided.

### FIELD OF THE INVENTION

The invention relates to a method of making metal halide arc tubes, more specifically arc tubes for use in metal halide arc lamps.

### BACKGROUND OF THE INVENTION

Shrink sealing refers to the process of making metal halide arc tubes and lamps without the use of a separate exhaust tube for pressurizing and depressurizing the tube and for inserting vaporizable doses of mercury and halide compounds. For each seal, the arc tube body material, typically quartz, is given an internal pressure lower than the ambient atmospheric pressure and is then heated and allowed to shrink down on an electrode assembly, thus capturing the electrode in the desired position.

Typically the mercury and halide doses are inserted, and then a shrink seal is formed near the midsection containing the doses. Formation of the shrink seal near the newly inserted doses may cause them to vaporize and contaminate the vacuum system. It would be desirable to minimize the possibility of halide vaporization and resultant contamination of the vacuum system. Another contamination problem may arise if hydrocarbons from the vacuum system enter the arc tube body and interfere with the subsequent function of the lamp. It would thus be desirable to minimize the possibility of hydrocarbon contamination of the arc tube body from the vacuum system.

After the halide doses and electrodes are sealed in place, a reflective coating is often applied to the exterior of the arc tube body. The electrode leads should be protected during application of the coating so as to remain unfouled.

### SUMMARY OF THE INVENTION

A method of producing a metal halide arc tube is provided. The method comprises the steps of providing an arc tube body having first and second ends; inserting a first electrode assembly and a second electrode assembly into the arc tube body, and creating first, second, third and fourth seals in the arc tube body. Each seal is formed by heating the arc tube body at a desired location while maintaining a gas pressure inside the arc tube body lower than the pressure outside the arc tube body. A first portion including the first end and one of the seals is removed, and a second portion including the second end and another of the seals is removed.

### BRIEF DESCRIPTION OF THE DRAWINGS

FIG. 1 is an elevation of an arc tube body following insertion of electrodes.

FIG. 2 is an elevation of an arc tube body following creation of a first seal between an electrode and an outer end of an arm of the arc tube body.

FIG. 3 is an elevation of an arc tube body following creation of a second seal encompassing an electrode.

FIG. 4 is an elevation of an arc tube body following insertion of mercury and halide doses and creation of a third seal between an electrode and an outer end of an arm of the arc tube body.

FIG. 5 is an elevation of an arc tube body following creation of a fourth seal encompassing an electrode.

FIG. 6 is an elevation of an arc tube body following application of a coating.

FIG. 7 is an elevation of an arc tube body following removal of the outer parts of the arms and trimming of the electrode assembly leads.

### DETAILED DESCRIPTION OF THE PREFERRED EMBODIMENTS OF THE INVENTION

In the description that follows and in the claims, when a preferred range, such as 5-25, is given, this means preferably at least 5, and separately and independently, preferably not more than 25.

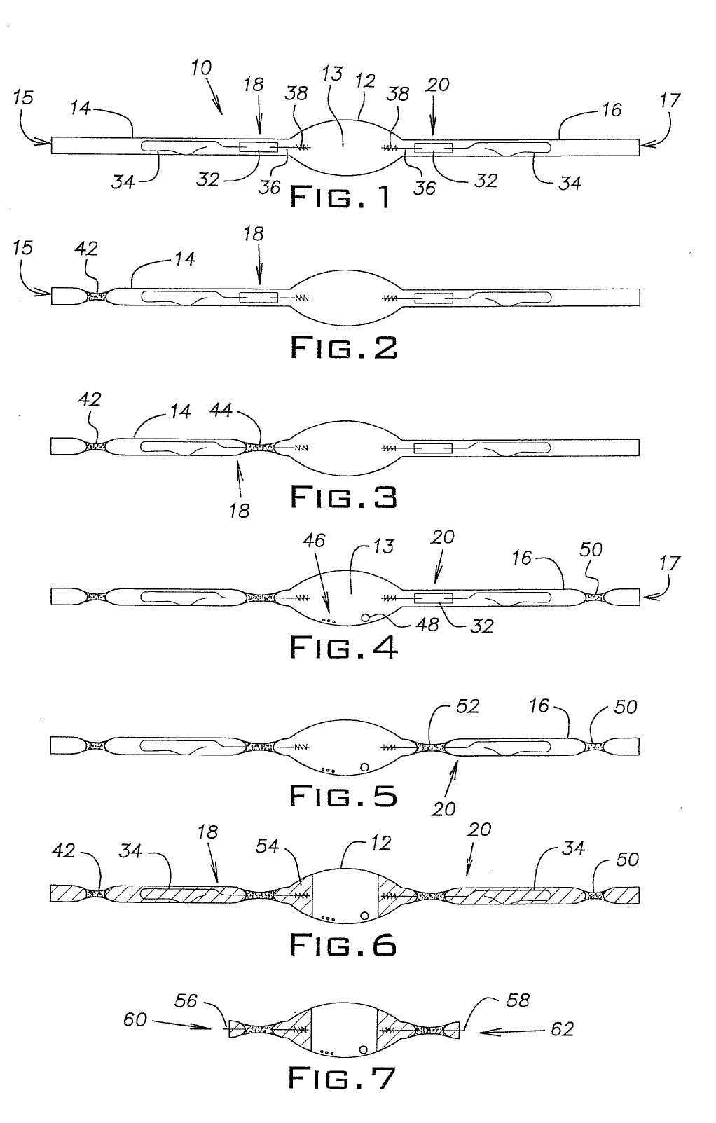

Referring to FIG. 1, an aspect of the method according to the invention begins with the provision of a pre-formed quartz arc tube body 10 having a bulbous midsection 12 and two arms 14, 16, each projecting in opposite directions from the midsection. Each arm has an outer end 15, 17. The arc tube body is seized in the headstock and tailstock of a lathe (not shown) having the capacity to rotate the arc tube body on its axis, evacuate the arc tube body, apply heat sufficient to melt the arc tube body, and supply appropriate fill gases to the arc tube body. Electrode assemblies 18, 20 are inserted into the arc tube body. Each electrode assembly has a molybdenum foil 32, a spring clip 34 attached to the foil, a tungsten shank 36 attached to the molybdenum foil, and a coil 38 attached to the tip of the shank. The spring clip and shank each project in opposite directions from the foil. Each electrode assembly is positioned in an arm with its spring clip projecting toward the outer end of the arm. The electrode assemblies are placed in the arc tube body so that the space between the coils is in the arc chamber 13, preferably defined by the bulbous midsection 12, and the distance between the coils is appropriate for the size and rating of the lamp. The arc chamber is preferably essentially centrally located in the arc tube body, between the electrode assemblies. The spring clip serves to temporarily hold the electrode assembly in place until the electrode assembly is sealed in place in the arc tube body.

Referring to FIG. 2, a first seal 42 is made by simultaneously rotating, evacuating, and heating the tube until the quartz melts and collapses. This seal is made, preferably between the molybdenum foil 32 of electrode assembly 18 and the adjacent outer end 15 of the arm 14 seized in the tailstock of the lathe, more preferably between the electrode assembly 18 and the adjacent outer end 15 of the arm 14 seized in the tailstock of the lathe. A vacuum is drawn from a tail stock pump while the head stock is blanked off. After this first seal is formed the interior of the arc tube body is protected from contaminants originating from the tail stock vacuum system.

Referring to FIG. 3, a second seal 44 is formed to encompass a central portion of electrode assembly 18, preferably at the foil 32 of the electrode assembly 18, in the same arm 14 as the first seal 42. Forming a seal at a central portion of the electrode assembly such as the molybdenum foil ensures that part of the electrode assembly will extend from each side of the seal, allowing passage of electricity through the seal via the electrode assembly. The second seal is also formed by rotating, evacuating and heating the tube until the quartz melts and collapses. The vacuum is drawn from the headstock through outer end 17 during the formation of the second seal. Following the formation of the second seal, doses of halide compound 46 and of mercury 48 are inserted into the arc chamber, as shown in FIG. 4. The halide doses typically comprise a mixture of the bromides or iodides of sodium, scandium, and thorium, but may contain any of the commonly used halides for high intensity discharge lamps. These include iodides and bromides of thallium, dysprosium, holmium, thulium, cerium, cesium, and calcium.

The insertion of the doses is generally performed with the assistance of gravity without moving the already-positioned electrode assemblies. This is best done by placing the arc tube body with its long axis in a vertical position with the open arm facing upward, and then releasing the doses into the arc tube body from a position above the electrode. Even if the doses strike the electrode assembly, they will generally move downward past the assembly and into the bulbous midsection without substantially changing the position of either electrode assembly. This is important, as any substantial change in the position of the electrode assembly which would require repositioning of the electrode assembly to ensure proper function of the arc tube. The use of a small halide pellet allows sufficient clearance for the pellet to move past the electrode. The doses can be introduced separately, or in combination.

Following insertion of the doses, the arc tube body is re-pressurized with a fill gas through outer end 17. Typical fill gases are argon, krypton, xenon, or mixtures thereof. Typical fill gas pressures are 20-500 torr.

It is desirable to maintain sub-atmospheric pressure in the arc tube body during the formation of the seals. During operation of the lamp the temperature and pressure of the fill gas will rise. Nevertheless, if a higher operating pressure is desired than can be provided by introducing a subatmospheric gas fill at ambient temperature, then the arc tube body, the gas fill, or both may be cooled during pressurization. This will allow more gas to be introduced into the arc tube body, while maintaining sub-atmospheric gas pressure in the arc tube body during manufacture.

Following insertion of the doses and pressurization, a third seal 50 is made, preferably between the molybdenum foil 32 of electrode assembly 20 and the outer end 17 of the arm 16, more preferably between the electrode assembly 20 and the outer end 17 of the arm 16. This seal is also made by heating and rotating the arc tube body along its axis. Because the pressure in the arc tube body is less than the ambient pressure, the quartz will collapse to form the seal when heated. By making the seal 50 at a distance from the arc chamber 13, rather than at foil 20, less heat is transferred to the halide doses 46 and vaporization of the halide doses is reduced or avoided. Thus contamination of the headstock by halide vapor escaping through outer end 17 is also reduced or avoided.

Referring to FIG. 5, a fourth seal 52 is made at a central portion of the electrode assembly 32, preferably at the foil 32 of the electrode assembly 20 in the same arm 16 as the third seal 50. This seal is also formed by rotating and heating the tube until the quartz melts and collapses. The sub-atmospheric pressure of the fill gas in the arc tube body will result in the quartz tube collapsing when softened by heating, as it did during formation of the third seal. As with formation of the third seal, cooling of the tube may be necessary to maintain the gas pressure in the arc tube body below ambient pressure.

Following formation of the fourth seal, an outer coating may be applied to the arc tube body. Outer coatings are generally used to reflect infrared radiation back into the arc chamber. This helps to ensure that a sufficiently high temperature is maintained on the interior of the arc chamber. Typically the central portion of the bulbous midsection will be masked off to prevent deposition of the coating in that region. In FIG. 6, an arc tube body 10 is shown with a coating 54 substantially covering the surface except for a central portion of the bulbous midsection 12. The coating is typically a single or multiple layer thin film of an alumina material, although other known coatings such as zirconia, tantala, silica, titania, or combinations thereof may be used. Seals 42 and 50 ensure that the coating is not deposited on spring clips 34 of electrode assemblies 18 and 20.

After the coating is deposited on the arc tube body, the ends of the arc tube body are removed, resulting in an arc tube body with two seals and two outer ends 60, 62. The spring clips 34 are trimmed, leaving two electrode leads 56, 58 for connection to a source of electrical energy. By following this procedure, contamination of the leads by the coating process is avoided.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of producing a metal halide arc tube comprising the steps of providing an arc tube body having first and second ends; inserting a first electrode assembly and a second electrode assembly into the arc tube body; creating first, second, third and fourth seals in the arc tube body, each seal being formed by heating the arc tube body at a desired location while maintaining a gas pressure inside the arc tube body lower than the pressure outside the arc tube body; removing a first portion of the arc tube body, the first portion comprising the first end and one of the seals; and removing a second portion of the arc tube body, the second portion comprising the second end and another of the seals.

2. A method according to claim 1, wherein the first seal is formed before the second, third, and fourth seals, the first seal being formed between a central portion of the first electrode assembly and the first end.

3. A method according to claim 2, further comprising the step of maintaining a reduced gas pressure inside the arc tube body while forming the first seal, said reduced gas pressure being maintained by blanking off the second end and evacuating gas from the first end.

4. A method according to claim 2, further comprising the step of positioning the first electrode assembly between the first end and an arc chamber, said arc chamber being essentially centrally located in said arc tube body.

5. A method according to claim 2, wherein the second seal is formed before the third and fourth seals, the second seal being formed so as to encompass a central portion of the first electrode assembly.

6. A method according to claim 5, further comprising the step of positioning the first electrode assembly between the first end and an arc chamber, said arc chamber being essentially centrally located in said arc tube body.

7. A method according to claim 5, further comprising the step of maintaining a reduced gas pressure inside the arc tube body while forming the second seal by evacuating gas from the second end.

8. A method according to claim 5, wherein the third seal is formed before the fourth seal is formed, the third seal being formed between a central portion of the second electrode and the second end.

9. A method according to claim 8, further comprising the step of positioning the second electrode between the first electrode and the second end.

10. A method according to claim 8, further comprising the step of forming the fourth seal so as to encompass a central portion of the second electrode assembly.

11. A method according to claim 1, comprising the further step of placing a dose of mercury and a dose of halide compound in the tube after forming the second seal.

12. A method according to claim 11, wherein the doses of mercury and of halide compound are placed in the arc tube body after the first and second electrode assemblies are placed in the arc tube body.

13. A method according to claim 12, wherein the doses of mercury and of halide compound are placed in the arc tube body without substantially changing the position of either electrode assembly.

14. A method according to claim 1, wherein a reduced gas pressure in the arc tube body is maintained while forming the third seal by introduction of a fill gas at a pressure of 20-500 torr.

15. A method according to claim 1, wherein the arc tube body is a quartz arc tube body.

16. A method of producing a metal halide arc tube comprising the steps of providing a quartz tube comprising a bulbous section, a first arm and a second arm, each arm extending from the bulbous section, and each arm having an outer end; inserting a first electrode assembly and a second electrode assembly into the quartz tube so that the electrode assemblies are a predetermined distance apart from each other and one electrode assembly is disposed in each arm, each electrode assembly comprising a foil, a spring clip attached to the foil and extending away from the bulbous section, a shank attached to the foil and extending toward the bulbous section, and a coil attached to the shank; reducing the gas pressure in the quartz tube by evacuating gas from the first arm's outer end while blanking off the second arm's outer end; creating a first seal in the first arm of the quartz tube between the electrode assembly disposed in the first arm and the outer end of the first arm by rotating and heating the quartz tube at the desired location until the quartz tube melts and collapses; then evacuating gas from the second arm's outer end to reduce pressure in the quartz tube between the first seal and the second arm's outer end; creating a second seal in the first arm at the location of the foil of the electrode assembly in the first arm by rotating and heating the quartz tube until the quartz tube melts and collapses on the foil; placing a dose of mercury and a dose of halide compound into the bulbous section; pressurizing the quartz tube between the second seal and the second arm's outer end with a fill gas to a pressure of 20-500 torr; creating a third seal in the second arm of the quartz tube between the electrode assembly disposed in the second arm and the outer end of the second arm by rotating and heating the quartz tube at the desired location until the quartz tube melts and collapses; creating a fourth seal in the second arm of the quartz tube at the location of the foil by rotating and heating the quartz tube at the desired location until the quartz tube melts and collapses; applying an external coating to the quartz tube; removing a section of each arm between the outer end of the arm and the foil; and trimming each spring clip to a desired length.
